(19) United States
(12) Patent Application Publication
(10) Pub. No.: US 2006/0091202 A1
(43) Pub. Date: May 4, 2006

(54) Media disc and gift card point-of-sale package

(76) Inventor: Lawrence Ron McInnis, Saratoga, CA (US)

Correspondence Address: LAW OFFICES OF THOMAS E. SCHATZEL;A Professional Corporation, Suite 240, 16400 Lark Avenue, Los Gatos, CA, 95032-2547, US

(21) Appl. No.: 10/982,102

(22) Filed: Nov. 4, 2004

(51) Int. Cl. G06F 7/08; G06Q 99/00

(52) U.S. Cl. 235/381; 705/1

(57) ABSTRACT

A gift card point-of-sale package comprises a payment card and optical recording disc packaged for merchandizing and display in a retail location. The gift card, optical recording disc, and backboard are printed with trademarks, logos, sales messages, and graphics that generate some gift-giving purchase interest in a retail buyer. The gift card includes a magnetic stripe payment card with recording information identifying the gift card point-of-sale package. Such information becomes automated business intelligence that can be communicated to the gift card sponsor, and used to analyze buyer behavior and sales performance. The optical recording disc comprises computer programs, video programming, musical performances, games, and interactive presentations. Its use is automatically reported over the Internet. The products and services offered by the gift card sponsor are related to the optical recording disc content. The backboard allows gift-givers to identify themselves to their recipients.

### BACKGROUND OF THE INVENTION

1. Field of the Invention

The present invention relates to media disc and gift card point-of-sale packages, and in particular to blister-carded retail merchandizing of trademark branded gift cards paired with synergistic computer, audio, and video discs.

2. Description of the Prior Art

Gift certificates used to be a common way for people to give gifts and let the recipient decide exactly what they want. Technology, especially in the form of magnetic-strip, barcode, and PIN-number payment cards, has transformed gift certificates into gift cards. These gift cards offer a certain degree of convenience for the consumer, and a major opportunity for the payment-card sponsor to collect and track consumer buyer behavior information.

Gift certificates and gift cards are very profitable for their sponsors. If the full value of every card got redeemed, the sponsor would still realize a profit on the retail sales of the items being purchased. But the reality is not every gift card gets used and some remainder amount is often left on the cards that are used. Such effects are called “breakage”. And until the gift card actually gets used after it was sold, the money in the bank for that time represents a huge “float”. The breakage and float associated with the gift card business is huge.

Gift card sales for 2003 were well over $40 billion in the United States alone, and that is expected to top $54 billion in 2004. Sales seem to be growing at an annual rate of 15-35%. Almost one-third of these purchases are “impulse” purchases, e.g., unplanned spur-of-the-moment when seen in a checkout counter. Thirty million consumers a month pass through Safeway Supermarket aisles every month. Consumers typically spend 20% more than the value of the card out of their own pocket, and such amounts to captive sales because the consumer-recipient was pulled into the store by the gift-giver.

Increasing gift card sales means increasing operating profit. The gift cards themselves have a 10% markup, and per unit costs are under $0.50. Premiums, discounts, and other incentives can be used to increase sales. By one estimate, consumers are three times more likely to buy a product that offers an inducement.

Milton Davila, et al., describe a multimedia gift card in United States Patent Publication US 2003/0141371 A1, published Jul. 31, 2003. A gift certificate and multimedia disc are packed together with “a label which supports or matches the cards overall theme or design.” The gift card is described as having a magnetic stripe or barcode with “easy access for retail sale.” The multimedia disc is described as not being limited to “any medium that can store digital data to include Compact Discs, Mini Compact Discs and DVD's.” The content possible includes “multimedia presentations, video, product information, store locations, databases, printable coupons, catalogs, personal and corporate history information, web site links, university information and curriculums.” The whole gift card is envisioned as a folding type that hides the payment card and multimedia disc inside.

Barry Fiala, et al., describe the activation and personalization of downloadable content related to a gift card in United States Patent Publication, US 2004/0139318 A1, published Jul. 15, 2004. Customizable or personalized digital content is included in digital greeting cards and other digital media, and is activated at a point of sale or direct purchase over the Internet. The content of a digital audio or video object or objects or material is delivered as a downloadable file or in streaming form. Additional or incidental content can been included based on information provided by the individuals involved in customizing, sending or receiving the material. The digital content is associated with greeting or gift cards sold through retail using point-of-sale activation or for digital audio or video material or objects purchased directly over the Internet. According to the Inventors, PIN numbers may be used with point-of-sale activation to limit unlicensed access or unlicensed copying to protect intellectual property rights.

Gift cards are easily branded with the sponsor's trademark, logo, and sales tag-lines. So gift cards that are branded with well-known trademarks and placed in high traffic retail locations like supermarkets will produce impulse sales.

Premiums and incentives can either be related or unrelated to the sponsor's product or services. Many are neuter, e.g., pricing discounts, rebates, or zero-interest loans. Better incentives involve another of the sponsor's products or services, e.g., upgrades, special previews, memberships, free passes, etc. Premiums and incentives can also either be related or unrelated to who are the recipient and/or the intended target market. Various consumer groups can be reached based on their age, gender, and interests. For example, MacDonald's restaurant advertising often targets young children, e.g., Ronald MacDonald and the Playground installations at many of their stores.

### SUMMARY OF THE INVENTION

Briefly, a gift card point-of-sale package embodiment of the present invention comprises a payment card and an optical recording disc blister-packaged on a backboard for merchandizing and display in a retail location. Each of the gift card, optical recording disc, and backboard are printed with trademarks, logos, sales messages, and graphics that generate some gift-giving purchase interest in a retail buyer. The gift card comprises a magnetic stripe payment card with magnetically recorded information, barcode, or PIN-number that identifies the gift card point-of-sale package. When used, such information becomes automated business intelligence that can be communicated back to the gift card sponsor. The information is used to analyze buyer behavior and sales performance. The optical recording disc comprises electronic content of some interest to the intended gift recipient. Such content includes computer programs, video programming, musical performances, games, and interactive presentations. When used, such reports its use automatically through the Internet. The products and services offered by the gift card sponsor are related to the optical recording disc content. The backboard provides a way for the gift-givers to identify themselves to their recipients.

An advantage of the present invention is that a retail product is provided that puts products in one hand of the consumer and the money to buy them in the other hand.

Another advantage of the present invention is that a gift card is provided that generates business intelligence related to consumer buying behavior.

A further advantage of the present invention is that a gift card point-of-sale package is provided that produces increased sales and profits over simple gift card sales.

Another advantage of the present invention is that a gift card point-of-sale package is provided that puts a sponsor's products in the consumer's hands at a very opportune time, e.g., when they have the power to buy.

A still further advantage of the present invention is that a gift card point-of-sale package is provided that can require the recipient to activate the payment card by logging onto a website using the disc, and thus to reveal the identity of the recipient and the item they have received.

These and other objects and advantages of the present invention will no doubt become obvious to those of ordinary skill in the art after having read the following detailed description of the preferred embodiments which are illustrated in the various drawing figures.

### IN THE DRAWINGS

FIG. 1 is a diagram of a gift card point-of-sale package embodiment of the present invention; and

FIG. 2 is a functional block diagram of a business method embodiment of the present invention, showing how the gift card point-of-sale package of FIG. 1 can be used to generate business intelligence and strategy.

### DETAILED DESCRIPTION OF THE PREFERRED EMBODIMENT

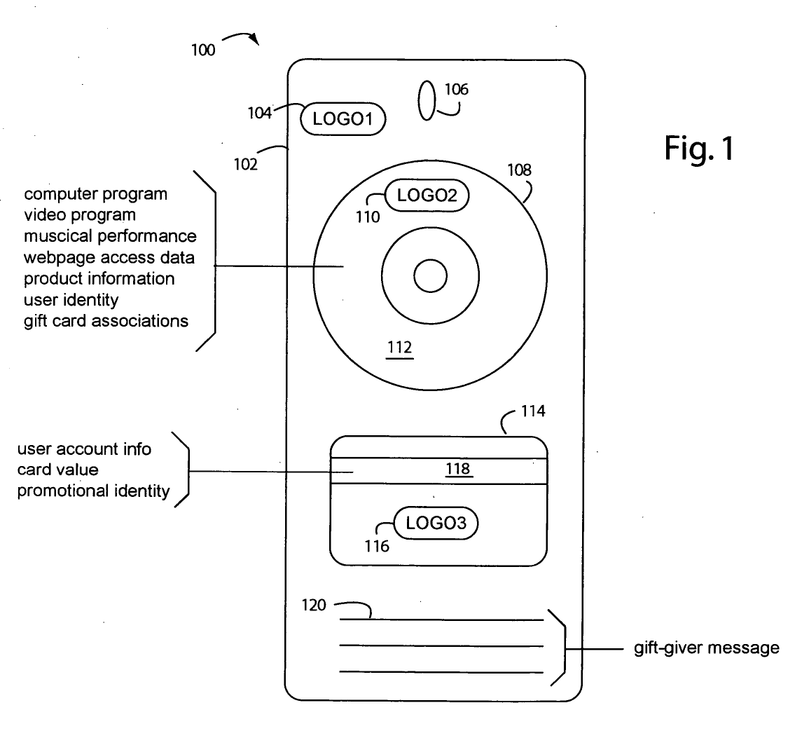

FIG. 1 represents a gift card point-of-sale package embodiment of the present invention, and is referred to herein by the general reference numeral 100. The gift card point-of-sale package 100 comprises a cardboard backboard 102 blister-packaged with plastic film and carrying a first trademark, logo, graphic, product identifier, or sales message (LOGO1) 104. A hole 106 is provided for a hanger display in a retail sales location, e.g., the check-out lane in a supermarket. An optical recording disc 108 also includes a second trademark, logo, graphic, product identifier, or sales message (LOGO2) 110. A digital data content 112 is optically recorded on the disc 108 and includes electronic content of some interest to the intended gift recipient. Such content includes computer programs, video programming, musical performances, games, interactive presentations, etc. Where Internet connections exist to the disc player being used, the fact of its use and the identity or interests of the gift recipient are sent in an automated report to the gift card sponsor. A gift card 114 also includes a third trademark, logo, graphic, product identifier, or sales message (LOGO3) 116. The gift card 114 is a payment card with account and product information magnetically recorded on a barcode or magnetic stripe 118. Typically, a magnetic stripe will be disposed on the payment card for machine-reading of magnetically recorded user account information. An optical barcode or RFID tag can alternatively be disposed on the payment card for machine-reading of optical or wireless-access user account information. A scratch-off panel may further be disposed on the payment card for validating user account information after purchase. A space 120 is provided that invites the gift-giving purchaser to identify themselves and write a brief message.

The gift card 114 carries some electronic money value that can be used by the gift recipient to purchase products or services. Activation may be required in the form of a website log-on using the optical recording disc 108 in an Internet-connected computer, or a call to a phone number. The digital data content 112 is limited to that which is of interest to the gift recipient and would be useful in combination with the ability to make a purchase using the gift card 114.

In general, a gift card point-of-sale package includes a barcode or magnetic-stripe plastic payment card with printing that identifies to a consumer where such may be used as a gift card and for what products or services. An optically recorded data disc with printing identifies to the consumer who produced it and what content it carries. The payment card and data disc are disposed in a retail display pack such that the printing on one side of each are visible to the consumer. For example, the display pack can be a blister pack. A place is provided on the display pack that encourages a purchaser to identify the package as a gift, and themselves, to a recipient who will ultimately use the plastic payment card to purchase the products or services. The data disc enables the consumer to use the plastic payment card to purchase the products or services.

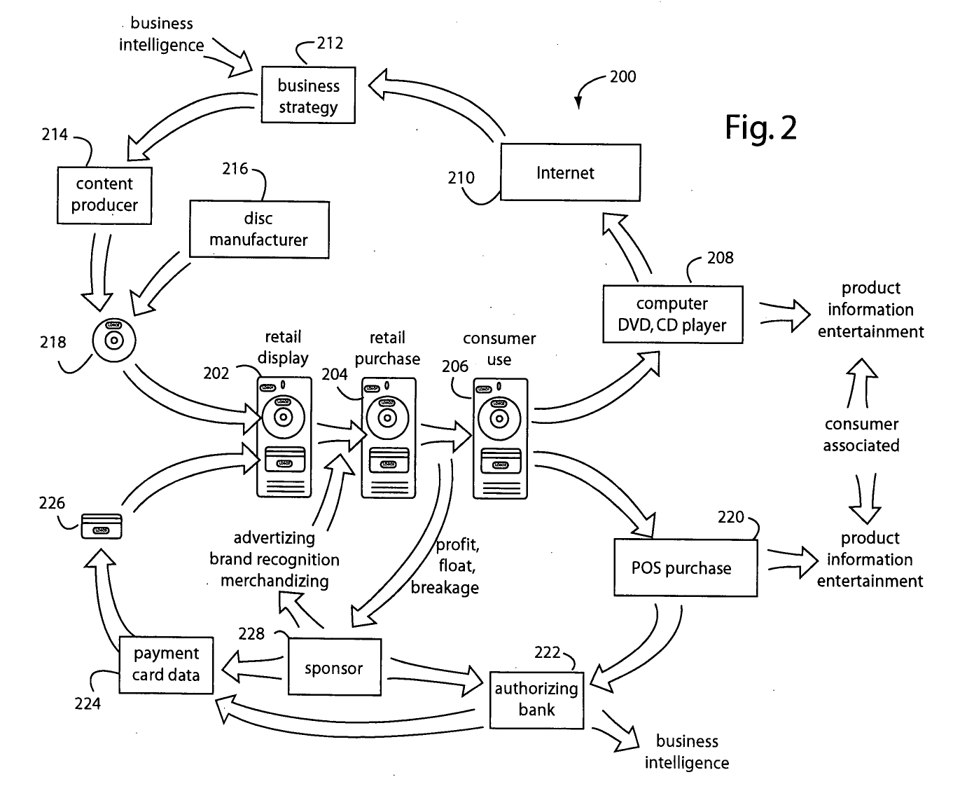

FIG. 2 represents a business method embodiment of the present invention, and is referred to herein by the general reference numeral 200. The business method 200 shows how a gift card point-of-sale package 202 can be used to generate business intelligence and strategy. The gift card point-of-sale package 202 is similar to that of FIG. 1 and is placed on retail display. Advertising, brand recognition, merchandising, and other marketing methods are used to induce the sale of the gift card point-of-sale package 202 to a gift-giver purchaser. A retail purchase 204 generates sales revenue, profits, float, and breakage. Until a consumer use 206 is made, the purchase price represents a financial float that can be used by the sponsor. When the consumer use 206 is made, any failure to use the full value represents breakage that can be pocketed by the sponsor. The actual consumer use 206 allows the sponsor to profit on the actual products or services being purchased by the retail gift recipient.

After receiving the gift card point-of-sale package, the recipient plugs the disc into a computer, DVD, CD, or game player 208. This outputs products, services, information, or entertainment from the player related to the gift card and what it can purchase. If a pathway exists for the player, a telephone, SMS message, e-mail, or Internet website connection 210 is made. Information about the product purchased and the gift recipient are communicated as automated business intelligence that contribute to a sponsor's business strategy 212. Such strategy is used to select or engineer appropriate digital content for the disc. A content producer 214 and a disc manufacturer 216 combine to make a disc 218. Such is then assembled and used in the retail display 202.

When the gift card itself is used by the recipient in a point-of-sale (POS) purchase 220, it generates or enables the acquisition of products, services, information, or entertainment. Such is related to the outputs of disc-player step 208. The POS activity is authorized by a bank 222 which generates business intelligence communicated to the business strategy 212. Such can include information about the product purchased, the dollar amount involved, a gift card series identifier, the payment card balances left, the place of use, and some identifying information about the user. All such information would be useful in analyzing the sponsor's sales, profits, and strategies.

Alternatively, the authorizing bank 222 can be a retailer's own POS system. For example, HOME DEPOT gift cards when used in any HOME DEPOT store do not need to involve the MasterCard, Visa, Discover Card, or American Express payment processing centers. The HOME DEPOT, in this example, can avoid the fees associated with accepting bank credit cards. The business intelligence collection opportunities are maximized because the retailer has access to all the payment card information and its use.

Initially, the authorizing bank 222 provides account data that is included in a payment card data 224. This is used to magnetically encode a gift card 226. Such is combined with the disc 218 for the retail display 202. A sponsor 228 includes data markers in the payment card data 224 that will be returned in business intelligence form via Internet 210 or the authorizing bank 220.

The business strategy 212 can also analyze from the business intelligence which combinations of cards, discs, backboards, messages, logos, and trademarks seem to work best to maximize sales and profits. The data and use restrictions placed on the cards and discs can be designed to force the recipient to provide useful information related to the products and services being purchased. They can also be used to limit the kind of products that can be purchased, and the places such can be purchased at. Movie theaters, sports arenas, and other captive venues use such leverage to charge higher prices.

A discrete business opportunity to partner with retailers and sponsors is represented by Internet step 210, business strategy step 212, content producer step 214, and disc step 218. A third party can offer marketing and merchandising services to already established retail sponsors, content providers, and gift card systems to provide the retail displays 202.

Retail display 202 represents a powerful consumer acquisition tool to creates immediate sales opportunities offline and online, and that enables a channel for communication, and customer retention. Disc 218 can include CD-ROM's with embedded technology for tracking insertion rates, viewing metrics, and click-thru activity. Consumers can be instantly transported to designated web sites for product purchases and/or additional information. Compared to prior art CDs, disc 218 delivers compelling product demos and interactive media to influence consumer behavior. System 200 can be used to quickly and easily identify millions of consumer profiles and preferences. It enables communication with key influencers, and it tracks insertion rates and allows detailed viewing of metrics to measure return-on-investment (ROI). Detailed statistics on disc insertion rates, viewing metrics, and click-thru rates providing instant and measurable ROI!

Merchandisers can showcase their latest products, services and corporate branding in an exciting, interactive format on the CD-ROM. Consumers are shown the latest products and entertainment offerings, and are compelled to use the gift card for their online or offline purchases.

Embodiments of the present invention can include sweepstakes, vacations and merchandise give-a-ways. The sweepstakes registration can be used to capture valuable consumer profile and demographic information.

Embodiments of the present invention further provide retailers and manufacturers the ability to introduce and showcase their products in new and exciting ways, and to make those efforts truly pay off by collecting data on all consumer interactivity. Method 200 is used to identify consumer profiles and preferences and measure and track consumer interaction with a CD ROM. Such provides detailed analysis and reporting, and opens a communication channel to identify and influence consumer buying behavior. Additional information may be found at www.acquire-inc.com.

It is important to deliver the right message, at the right time, and to the right consumer. The interactive CD-ROM programs allow messages to be delivered in interactive, entertaining formats at a time when the consumer is listening. Our expertise and experience in digital and interactive media ensure that your story will be presented in a compelling and engaging format, and that your corporate branding will be delivered in a professional and consistent manner.

Our unique software and data acquisition tools deliver instant and measurable ROI. We open a direct line of communication with your customer so you can be sure your marketing and promotional campaigns are truly “hitting-the-mark”

In general, embodiments of the present invention combine and package a Media Disc (CD and/or DVD ROM) with a Gift/Promotional/Incentive Card on a paper backboard fused together with clear protective material. Such is used to establish and demonstrate a direct connection between a promotion on a media disc and a merchandise purchase from the gift card at the retailer who issued the gift card. These help to establish a communication channel between a merchant and consumer from the media disc, via e-mail and/or internet. A consumer is lead directly from the media disc to a web page featuring a product showcased on the media disc. This allows a consumer to buy merchandise featured on the media disc online using their gift card, because the consumers are taken directly to a product page at a retailer website.

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the “true” spirit and scope of the invention.

1-7. (canceled)

8. A gift card business method, comprising:
packaging an electronic payment card and an optical recording disc together in a packaged gift card for merchandising and display in a retail location, wherein said gift card, optical recording disc, and backboard are printed with trademarks, logos, sales messages, and graphics targeted to generate a gift-giving purchase interest in a retail buyer, and wherein said gift card comprises a magnetic stripe payment card with magnetically recorded information;
detecting that either of said electronic payment card and optical recording disc have been used;
communicating data from the step of detecting back to a gift card sponsor as feedback for an on-going business strategy; and
analyzing buyer behavior and sales performance of retail sales of said electronic payment card with information obtained in the step of communicating data.

9. The method of claim 8, further comprising
modifying an electronic content in said optical recording disc targeted to interest an intended gift recipient to use said electronic payment card depending on a decision made in the step of analyzing.

10. The method of claim 9, further comprising:
using computer programs, video programming, musical performances, games, and interactive presentations in said electronic content to report its use automatically through the Internet.

11. The method of claim 8, further comprising:
printing on said electronic payment card a way for gift-givers to identify themselves to their gift recipients.
